(19) United States
(12) Patent Application Publication
(10) Pub. No.: US 2005/0232302 A1
(43) Pub. Date: Oct. 20, 2005

(54) Translation between SCPI protocol communications and .NET protocol communications

(76) Inventors: Timothy Nephi Tillotson, Heber, UT (US); Sara Ting, Cupertino, CA (US); Nathan A. Berg, Fort Collins, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/825,466

(22) Filed: Apr. 15, 2004

(51) Int. Cl. G01R 35/00; H04J 3/22; G01D 21/00; H04J 3/24; G01P 21/00; G06F 19/00; H04J 3/16; G06F 15/16; G01M 19/00; G01D 18/00

(52) U.S. Cl. 370/466; 709/208

(57) ABSTRACT

A method for translating between Standard Commands for Programmable Instrumentation (SCPI) protocol and .NET protocol communications. When the communication from the client is a SCPI protocol command, it is converted to a .NET protocol command. The .NET protocol command is evaluated to determine the validity of the parameters sent from the client with the SCPI protocol command. Otherwise, when the communication is a SCPI protocol query from the client, the SCPI protocol query is converted to a .NET protocol query, and the .NET protocol query is evaluated to determine the validity of the parameters sent from the client with the SCPI protocol query. When the communication is intended for an instrument application, an appropriate Application Program Interface (API) responsive to method calls in the .NET protocol is then called.

### BACKGROUND

Initially, electronic instruments were stand-alone units designed for rather limited and specific applications. Within the instrument industry, a wide variety of instrument command sets were developed which required instrument users to learn a new vocabulary for each instrument. This proliferation of command sets resulted in users spending a great deal of time learning how to program instruments, made maintenance of test programs difficult, and made it difficult to upgrade test systems as new equipment became available. In order to reduce development costs, various standard electrical and mechanical interfaces were developed for instruments and other electronic devices. With the advent of computer communication with and computer control of instruments and systems of instruments, standardized signal protocols and other standardized electrical and mechanical interfaces became more prevalent. These protocols were mainly intended to set standards for digital messages sent over these interfaces.

The Standard Commands for Programmable Instrumentation (SCPI) protocol standard was developed to define a set of commands for controlling programmable test and measurement devices in instrumentation systems. An instrumentation system is a collection of test and measurement devices connected by a communication bus to a control computer called the system controller. An instrumentation system may include stand-alone devices like IEEE 488 instruments or instrument cards in an enclosure such as a VXIbus rack.

Client processes often located on remote computers address commands, which may be, for example, a command to apply a signal, make a measurement, perform a calibration, or the like to one or more instruments over the bus. These commands are called program messages. Instruments may also send response messages back to the clients. The response messages may be measurement results, instrument settings, error messages, or the like. Prior to the SCPI standard, the commands that controlled a particular device function varied between instruments which had similar capabilities. SCPI provided a uniform and consistent language for the control oftest and measurement instruments. The same commands and responses can control corresponding instrument functions in SCPI equipment, regardless of the supplier or the type of instrument.

For instance, the command to measure a frequency is the same whether the measurement is made by an oscilloscope or a counter. The set of commands to control multimeters from two manufacturers differs only in places where the underlying hardware has different capabilities. Thus, instruments from different vendors can be expected to be essentially interchangeable in many applications.

SCPI provides a means to perform simple operations. The MEAS (measure) command, for example, can configure and read data from an instrument. When the program message “:MEAS:VOLT:AC?” is received by a voltmeter, for example, the meter will select settings and configure its circuitry for an AC voltage measurement, initiate the measurement, and return the result to the system controller. The question mark at the end of the command instructs the voltmeter to return the measured value to the controller. As another example, the SCPI command “:MEAS:FREQ?” returns a frequency measurement from an oscilloscope or a counter, despite great internal differences in the hardware of the instruments.

SCPI commands are organized in hierarchical structures referred to as trees. In the above two commands, “MEAS” is a parent node in a SCPI tree while “VOLT” is one child node of that parent and “FREQ” is another child node.

A central feature of the SCPI standard is the Command Reference which is a list of definitions for all the program messages. These definitions specify precisely the syntax and semantics for every SCPI message. Instrument functions covered by the standard may only be controlled through SCPI commands. However, SCPI was designed with a modular structure that permits commands controlling new functions to be added at any time. The Hewlett-Packard Interface Bus (HPIB) interface system, also known as the General-Purpose Interface Bus (GPIB) or by its Institute of Electrical and Electronic Engineers (IEEE) specification number IEEE 488, is a scheme by which groups of devices may be connected to a controlling computer and communicate under its direction. Instruments from multiple vendors can be operated in the same HPIB system. SCPI commands can be implemented on an instrument using any sort of interface, as for example, HPIB, serial/RS-232, VXI backplane, or the like, but they are especially common on HPIB busses.

The IEEE 488.1 standard defines hardware for an instrumentation bus. It is a digital bus with lines for the serial transfer of data bytes, plus extra control and handshaking lines. The IEEE 488.2 is an additional standard that defines protocols for data/command exchange between controller and instruments, basic data formats, systematic rules for program messages, and definition of instrument status structures. IEEE 488.2 also defines some common commands covering instrument functions that are universally applicable. However, IEEE 488.2 does not define commands or data structures for specific applications. Instrument makers are free to define the commands that control the primary functions of their instruments. SCPI builds upon IEEE 488.2 by standardizing these primary functions.

.NET is an open software standard initially developed by Microsoft which is becoming more and more popular for use in developing applications for instruments and instrument systems in the test and measurement field. Since a large majority of test and measurement instruments and systems are connected to one or more computers and since .NET was developed primarily for use with computer controlled applications, .NET has become a standard development platform for instruments and instrument systems. As such, .NET may well eventually replace SCPI as the application language of choice in a large number of instruments and instrument systems.

### SUMMARY

In representative embodiments, a method for translating between Standard Commands for Programmable Instrumentation (SCPI) protocol and .NET protocol communications is disclosed. When the communication from the client is a SCPI protocol command, it is converted to a .NET protocol command. The .NET protocol command is evaluated to determine the validity of the parameters sent from the client with the SCPI protocol command. Otherwise, when the communication is a SCPI protocol query from the client, the SCPI protocol query is converted to a .NET protocol query, and the .NET protocol query is evaluated to determine the validity of the parameters sent from the client with the SCPI protocol query. When the communication is intended for an instrument application, an appropriate Application Program Interface (API) responsive to method calls in the .NET protocol is then called.

In another representative embodiment, a system for translating between Standard Commands for Programmable Instrumentation (SCPI) protocol and .NET protocol communications is disclosed. The system comprises a parser module and an evaluator. The parser module is configured to receive a Standard Commands for Programmable Instrumentation (SCPI) protocol communication from a client and to translate the SCPI protocol communication into a .NET protocol communication. The evaluator is configured to evaluate the .NET protocol communication to determine the validity of the parameters sent from the client with the SCPI protocol communication.

Other aspects and advantages of the present disclosures will become apparent from the following detailed description, taken in conjunction with the accompanying drawings, illustrating by way of example in representative embodiments the principles of the invention.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1 is a drawing of a block diagram of a measurement system as described in various representative embodiments.

FIG. 2 is a drawing of a block diagram of communication paths in the measurement system of FIG. 1.

FIG. 3 is a drawing of a block diagram of one of the communication paths of FIG. 2.

FIG. 4 is a drawing of a block diagram of another of the communication paths of FIG. 2.

FIG. 5 is a drawing of a block diagram of yet another of the communication paths of FIG. 2.

FIG. 6 is a drawing of a flow chart of a method for transforming protocol of communications on one of the communication paths of FIG. 3.

FIG. 7 is a drawing of a flow chart of another method for transforming protocol of communications on one of the communication paths of FIG. 3.

FIG. 8 is a drawing of a flow chart of a method for transforming protocol of communications on the communication path of FIG. 4.

FIG. 9 is a drawing of a flow chart of a method for transforming protocol of communications on the communication path of FIG. 5.

### DETAILED DESCRIPTION

As shown in the drawings for purposes of illustration, the present patent document relates to novel methods for the translation of Standard Commands for Programmable Instrumentation (SCPI) protocol communications to .NET protocol communications. In the past a large number of instrument applications, as well as the client programs accessing those instrument applications, were written using the SCPI communication protocol. Currently more and more instrument applications, both new and updated, are being written in .NET which is an open software standard initially developed by Microsoft. Typically clients would prefer not to expend effort changing their programs from SCPI to .NET even though their programs may now be accessing instrument applications that are written in .NET. Representative embodiments disclosed herein provide techniques for the translation of SCPI protocol commands to .NET protocol commands and vice versa.

As used herein, the term “.NET protocol communications” includes mechanisms that can be used to call members of a class written for the .NET framework. Such communications include, but are not limited to, direct API calls, invocation using reflection, remote API calls using RPC mechanisms such as .NET remoting, etc.

In the following detailed description and in the several figures of the drawings, like elements are identified with like reference numerals.

Standard communication protocols are used in various industries. Standard Commands for Programmable Instruments (SCPI) is one such protocol commonly used in the Test and Measurement industry. SCPI comprises a common set of commands that instruments of a particular type will understand. For example, as a general rule, voltmeters and spectrum analyzers will understand particular sets of SCPI commands which control various functions on these instruments. Instrument functionality varies depending upon instrument manufacturer and type. Product differentiation is enhanced by the manufacturer by the addition of various capabilities to the instrument. SCPI is coded as an ASCII string and has a hierarchical command structure. At the top level could be an instruction to select the general function to perform, such as perform measurement or calibrate a system or subsystem. The next level could be a more specific statement of what the function is to perform, for example measure a frequency, voltage, or current in the item selected for measurement. Under voltage, for example, might be the type of voltage, i.e., DC voltage (direct current voltage) or AC voltage (alternating current voltage). A command might be “Measure voltage DC”. Each of these items “Measure”, “Voltage” and “DC” are considered to be a SCPI node, and the collection of all SCPI nodes in an instrument is a SCPI tree. In the instrument, a SCPI parser waits and listens for a SCPI command. When the SCPI parser receives a SCPI command that it understands, it identifies the correct SCPI node that corresponds to the SCPI command and instructs that node to perform the requested function.

However, not all instruments use SCPI for their resident command language API's, and computers used in the control of instruments do not always use a SCPI command set. There are potentially several different command languages that the computer can communicate with an instrument. In addition to SCPI, a computer or system often uses .NET.

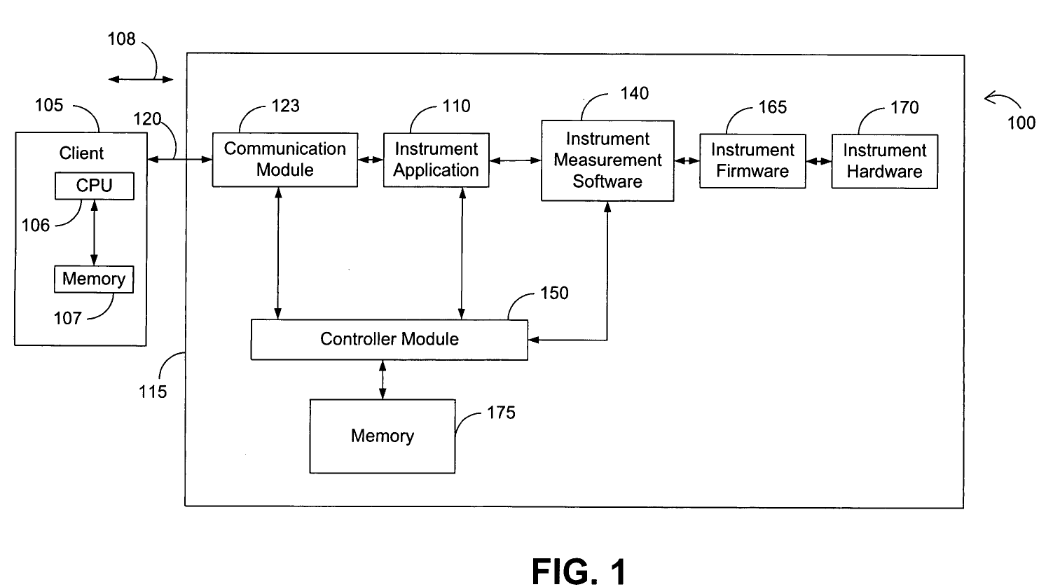

FIG. 1 is a drawing of a block diagram of a measurement system 100 as described in various representative embodiments. In the embodiment of FIG. 1, a client 105 is connected to an instrument 115 via a communication link 120 over which communications 108 can flow back and forth between the client 105 and the instrument 115. The client typically comprises a central processing unit (CPU) 106 or other control module 106 and a memory 107, also referred to herein as a memory module 107. In the instrument 115, the communication link 120 is connected to a communication module 123. Under control of a controller module 150 which is connected to another memory 175, also referred to as memory module 175, communications 108 to and from an instrument application 110, also referred to herein as an application 110 and as a .NET application 110, are translated, for example, between Standard Commands for Programmable Instrumentation (SCPI) protocol communications and .NET protocol communications.

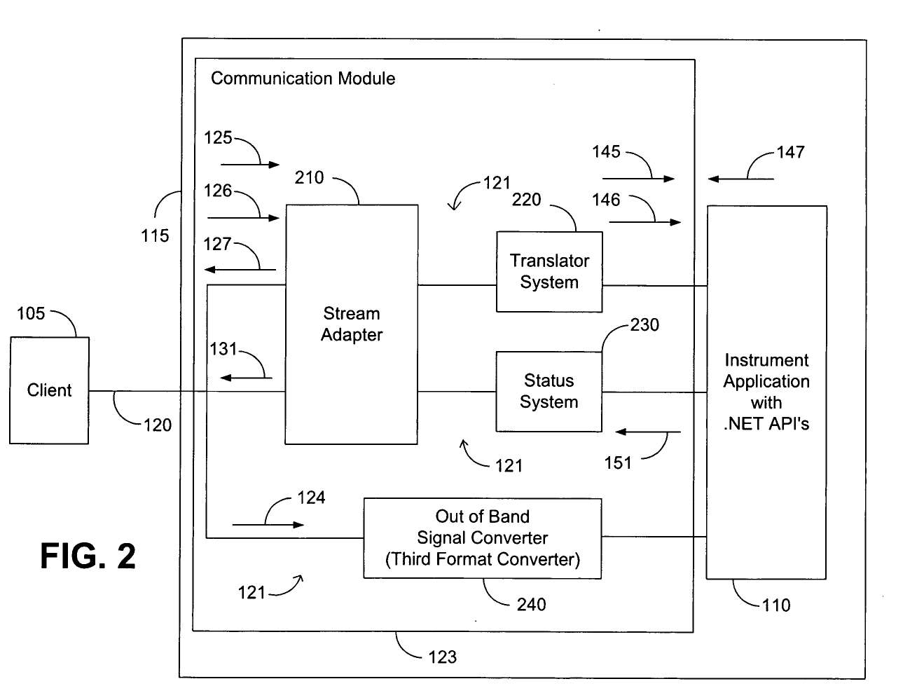

Communications 108 controlling the functioning of the instrument 115 are generically referred to as remote procedure control (RPC) commands 125 and herein as commands 125 (see FIG. 2). Before transmission the RPC commands 125 are formatted to a client specific protocol 128 which could be, for example, the SCPI protocol 128 (not shown explicitly in the drawings). A number of standard sets of program calls or routines referred to as Application Program(ming) Interface (API) functions are used to control various applications on the instrument 115. The set of API functions which the application 110 on the instrument 115 has been programmed to understand are written using RPC functions or commands resident on the instrument 115 and which are referred to as the instrument resident or instrument native API's. Similarly, the format or grammar used to write these API's is referred to as the native language of the instrument 115. The instrument native API's are formatted in conformance to an application specific protocol 129 (not shown explicitly in the drawings) which could be, for example, a .NET protocol 129. In order to control the instrument 115, commands 125 reaching instrument measurement software 140 need to conform to the application specific protocol 129. The communication module 123 translates the client specific protocol 128 commands 125 sent to the instrument 115 by the clients 105 into translated commands 145 (see FIG. 2) having .NET protocols 129 which the application 110 is capable of understanding and reacting appropriately to.

In a representative implementation, the application 110 sends instructions from these translated commands 145 to the instrument measurement software 140 which in turn transfers these instructions to instrument firmware 165. The instrument firmware 165 finally transfers the required instructions to instrument hardware 170 for performing the requested task.

FIG. 2 is a drawing of a block diagram of communication paths 121 in the measurement system of FIG. 1. Three communication paths 121 are shown in FIG. 2. The top communication path 121 of FIG. 2 transfers communications 108 which are in the form of commands 125 and queries 126 from the client 105 to the instrument application 110. The protocols of both the commands 125 and the queries 126 are translated, for example, from SCPI protocol to .NET protocol by communication module 123. Response messages 127 are transferred from the instrument application 110 to the client 105, and the protocol of the response messages 127 are translated, for example, from .NET protocol to SCPI protocol by communication module 123. The middle communication path 121 transfers a notification of event occurrence 131 in the instrument application 110 to the client 105. While the bottom communication path 121 transfers out of band signals 124, which are typically out of band IEEE 488.1 signals 124 and which are also referred to herein as client-to-instrument application signals 124 and out of band IEEE 488.1 protocol signals 124, from the client 105 to the instrument application 110.

A stream adapter 210 adapts the commands 125 and queries 126 from the client 105 to .NET stream format and adapts response messages 127 from the instrument application 110 .NET stream format to the SCPI format. A translator system 220 translates the SCPI protocol of commands 125 and queries 126 from the client 105 into translated commands 145, which could be, for example, .NET protocol translated commands 145, and translated queries 146, which could be, for example, .NET protocol translated queries 146, which are transferred to the instrument application 110. The translator system 220 also translates application-response messages 147, which could be, for example, .NET protocol application-response messages 147 and which are also referred to herein as .NET protocol response messages 147, from the instrument application 110 into, for example, SCPI protocol response messages 127, also referred to herein as SCPI protocol response messages 127, which are then transferred to the client 105.

In the middle communication path 121, a status system 230 obtains application-notification of event occurrence 151 with associated detail information from the instrument application 110. Information from the application-notification of event occurrence 151 is formatted appropriately by the stream adapter 210 before such notification is transferred asynchronously to the client 105 as notification of event occurrence 131.

In the bottom communication path 121, an out of band signal 124, which could be an out of band IEEE 488.1 signal 124 and which is also referred to herein as a client-to-instrument application signal 124, is converted to a .NET signal by out of band signal converter 240, also referred to herein as third format converter 240 and as a third format converter module 240.

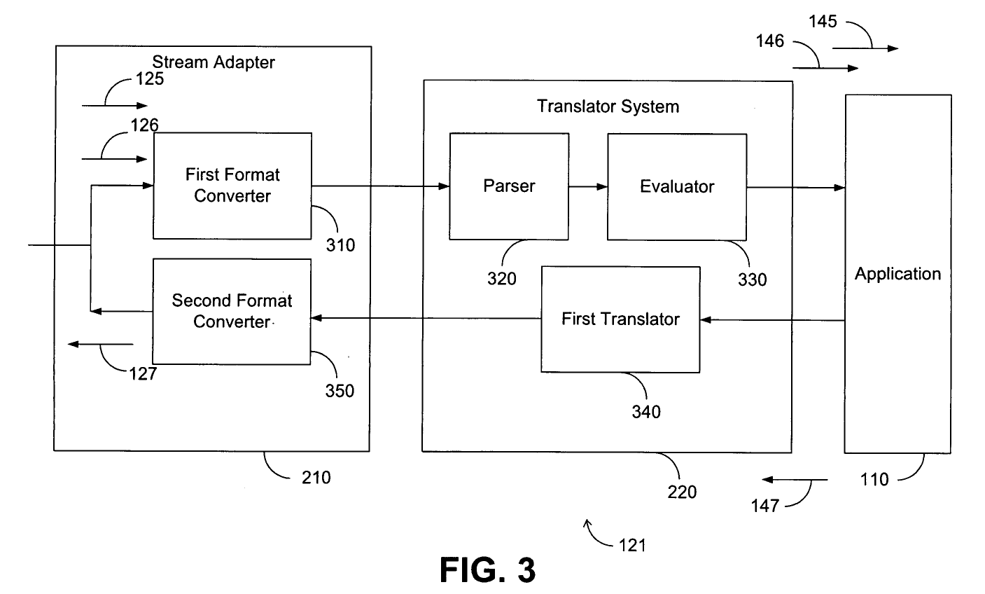

FIG. 3 is a drawing of a block diagram of one of the communication paths 121 of FIG. 2. In particular, FIG. 3 is a more detailed drawing of the top communication path 121 of FIG. 2. The top communication path 121 of FIG. 2 transfers commands 125 and queries 126 from the client 105 to the instrument application 110. The protocols ofboth the commands 125 and the queries 126 are translated from SCPI protocol to .NET protocol. The response messages 127 are transferred from the instrument application 110 to the client 105, and the protocol of the response messages 127 are translated from .NET protocol to SCPI protocol.

A first format converter 310, also referred to herein as a first format converter module 310, within the stream adapter 210 adapts the commands 125 and queries 126 from the client 105 to the .NET stream format. A parser 320, also referred to herein as a parser module 320, within the translator system 220 translates the SCPI protocol of commands 125 and queries 126 from the client 105 into the .NET protocol commands 125 and .NET protocol queries 126. The parser 320 then transfers the commands 125 and queries 126 to an evaluator 330, also referred to herein as an evaluator module 330 and also within the translator system 220. which are transferred to the instrument application 110. The translator system 220 also translates the .NET protocol of application-response messages 147 from the instrument application 110 into SCPI protocol response messages 127 which are transferred to the client 105. The evaluator 330 evaluates the semantics of the commands 125 and queries 126 which are now in the .NET protocol in order to determine the validity of the parameters sent with the commands 125 and queries 126 from the client 105. The evaluator 330 then calls the Instrument application 110 API.

When a response message 127 from the instrument application 110 is required, the instrument application 110 prepares such a response message 127 and transfers it to a first translator 340, also referred to herein as a first translator module 340, which could be, for example, a .NET to SCPI translator 340, which translates the .NET protocol of the response message 127 as prepared by the instrument application 110 into the SCPI protocol, i.e., into a SCPI language response. A second format converter 350, also referred to herein as a second format converter module 350, converts the format stream of the response message 127 as translated into the SCPI language by the first translator 340 into the SCPI format order. The second format converter 350 then transfers the response messages 127 to the client 105.

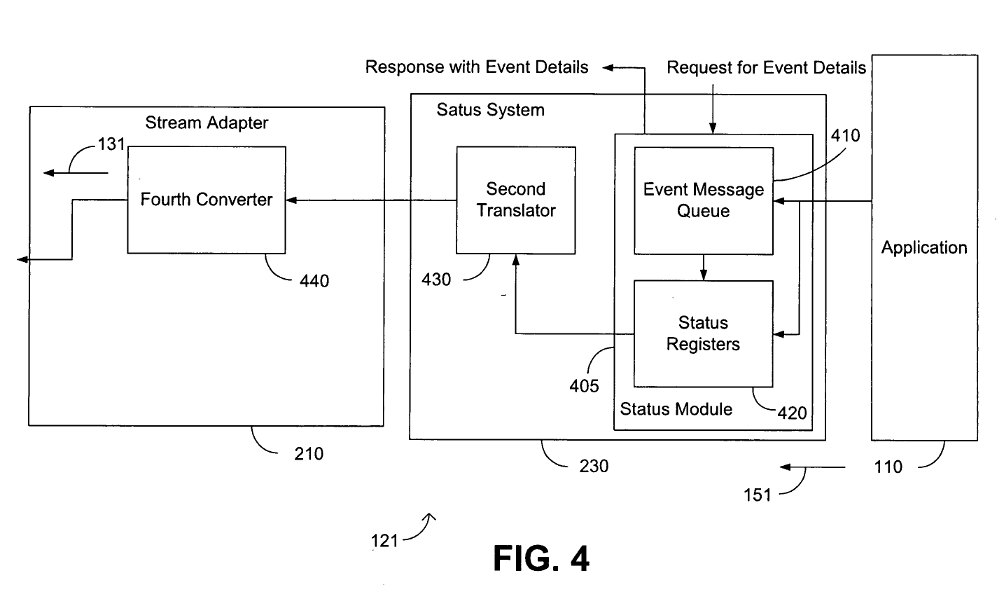

FIG. 4 is a drawing of a block diagram of another of the communication paths 121 of FIG. 2. In particular, FIG. 4 is a more detailed drawing of the middle communication path 121 of FIG. 2. The middle communication path 121 transfers a notification of event occurrence 131 in the instrument application 110 to the client 105.

In the middle communication path 121, the status system 230 obtains application-notification of event occurrence 151 with associated detail information from the instrument application 110. Information from the application-notification of event occurrence 151 is formatted appropriately by the stream adapter 210 before such notification is transferred asynchronously to the client 105. The instrument application 110 transfers notice of event occurrence to a status module 405 in the status system 230 which is typically a SCPI status system 230. Status registers 420 within the status module 405 record the event occurrence and/or records the event occurrence in an event message queue 410.

The client 105 is asynchronously notified by the instrument application 110 that an event has occurred via the following steps: (1) the status module 405 via the status registers notifies a second translator 430, also referred to herein as an event translator 430 and as an event translator module 430, of event occurrence, (2) the event translator 430 translates the indication of event occurrence from the status module 405 into, for example, a SCPI status stream, (3) the event translator 430 transfers its output to a fourth converter 440 in the stream adapter 210, and (4) the fourth converter 440 in the stream adapter 210 converts the SCPI status stream to IEEE 488.1 protocol and transferred to the client 105 via the communication link 120.

In response to above notification that an event has occurred, the client 105 can send a query 126 to the instrument application 110 inquiring as to the details of the event. The query 126 is sent to the instrument application 110 via the top communication path 121 and method discussed in FIG. 3. The instrument application 110 responds to the query 126 by initiating a response message 127 using information from the status module 405. Again, the response message 127 to the client 105 occurs via the process of FIG. 3.

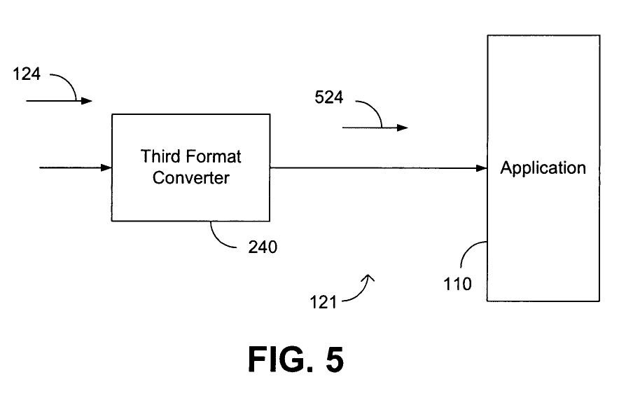

FIG. 5 is a drawing of a block diagram of yet another of the communication paths 121 of FIG. 2. In particular, FIG. 5 is a more detailed drawing of the bottom communication path 121 of FIG. 2. The bottom communication path 121 transfers out of band IEEE 488.1 signals 124, from the client 105 to the instrument application 110. In the bottom communication path 121 of FIG. 2, the out of band IEEE 488.1 signal 124 is converted to a .NET event by the third format converter 240. The out of band IEEE 488.1 signal 124 is sent from the client 105 to the instrument application 110 effecting control of the instrument application 110 by the client 105. The client 105 sends the out of band signal 124 to the instrument application 110 asynchronously. The third format converter 240 converts the out of band IEEE 488.1 signal 124 into an event signal 524 which could be, for example, a .NET event signal 534. The third format converter 240 transfers the .NET event signal 524 to the instrument application 110. These client-to-instrument application signals 124 could be, for example, “Device Clear”, “Addressing State Changed”, and/or “Change your Remote Local State”. The out ofband signals 124 signals are sent by the client 105 to control the state or condition of the instrument application 110.

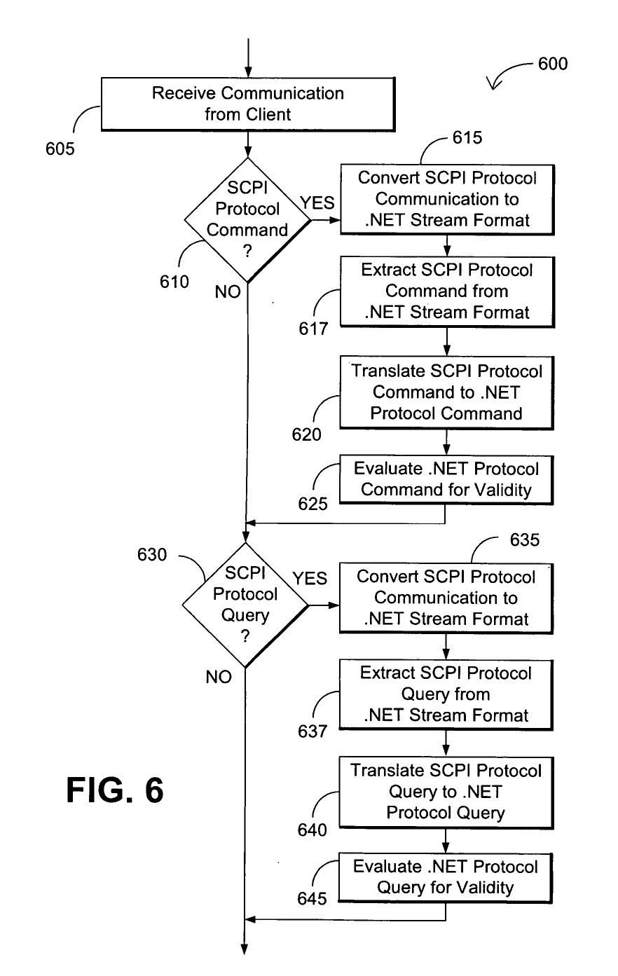

FIG. 6 is a drawing of a flow chart of a method 600 for transforming protocol of communications 108 on one of the communication paths 121 of FIG. 3. The flow chart of FIG. 6, describes the method 600 for translating and transferring commands 125 and queries 126 from the client 105 to the instrument application 110. The protocols of both the commands 125 and the queries 126 are translated from SCPI protocol to .NET protocol. In block 605 of FIG. 6, a communication 108 which is either a command 125 or a query 126 is received from the client 105 by the communication module 123 of the instrument 115. Block 605 then transfers control to block 610.

When the communication 108 is a SCPI protocol command 125, block 610 transfers control to block 615. Otherwise block 610 transfers control to block 630.

In block 615, the command 125 is converted to .NET stream format. Block 615 then transfers control to block 617.

In block 617, the SCPI protocol command 125 is extracted from the .NET stream format. Block 617 then transfers control to block 620.

In block 620, the protocol of the command 125 is translated to .NET protocol. Block 620 then transfers control to block 625.

In block 625, the .NET protocol command 125 is evaluated for validity. In particular, block 625 evaluates the validity of the parameters of the .NET protocol command 125. Block 625 then transfers control to block 630.

When the communication 108 is a SCPI protocol query 126, block 630 transfers control to block 635. Otherwise block 630 transfers the communication 108 to the instrument application 110 and terminates the process.

In block 635, the query 126 is converted to .NET stream format. Block 635 then transfers control to block 637.

In block 637, the SCPI protocol query 126 is extracted from the .NET stream format. Block 637 then transfers control to block 640.

In block 640, the protocol of the query 126 is converted to .NET protocol. Block 640 then transfers control to block 645.

In block 645, the .NET protocol query 126 is evaluated for validity. In particular, block 645 evaluates the validity of the parameters of the .NET protocol query 126. Block 645 then transfers the communication 108 to the instrument application 110 and terminates the process.

In an alternative embodiment, blocks 615 and 617 are omitted from FIG. 6 with block 610 transferring control to block 620 when the communication 108 is a SCPI protocol command 125 in block 610. Blocks 635 and 637 are also omitted from FIG. 6 with block 630 transferring control to block 640 when the communication 108 is a SCPI protocol query 125 in block 630.

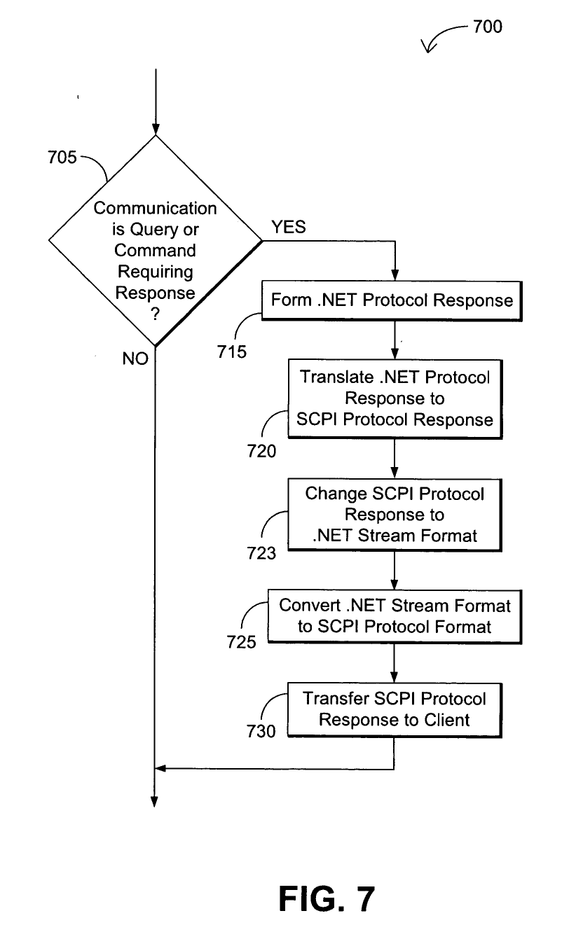

FIG. 7 is a drawing of a flow chart of another method 700 for transforming protocol of communications 108 on one of the communication paths 121 of FIG. 3. The flow chart of FIG. 7, describes the method 700 for translating and transferring response messages 127 from the instrument application 110 to the client 105. The protocol of the response messages 127 are translated from .NET protocol to SCPI protocol. Then the response messages 127 are transferred to the client 105.

When the communication 108 received from the client 105 as described above in connection with the flow chart of FIG. 6 is a query 126 or command 125 requiring a response from the instrument application 110, block 705 transfers control to block 715. Otherwise block 705 terminates the process.

In block 715, the instrument application 110 forms the response message 127 in the .NET protocol in response to the query 126 or command 125 received from the client 105. Block 715 then transfers control to block 720.

In block 720, the protocol of the response message 127 is translated from .NET protocol to SCPI protocol. Block 720 then transfers control to block 723.

In block 723, the SCPI protocol response message 127 is changed to .NET stream format. Block 723 then transfers control to block 725.

In block 725, the .NET stream format of the response message 127 is converted to SCPI protocol format response message 127. Block 725 then transfers control to block 730.

In block 730, the response message 127 in SCPI protocol is transferred to the client 105 and the process is terminated.

In an alternative embodiment, blocks 723 and 725 are omitted from FIG. 7 with block 720 transferring control to block 730 following completion of all other actions by block 720.

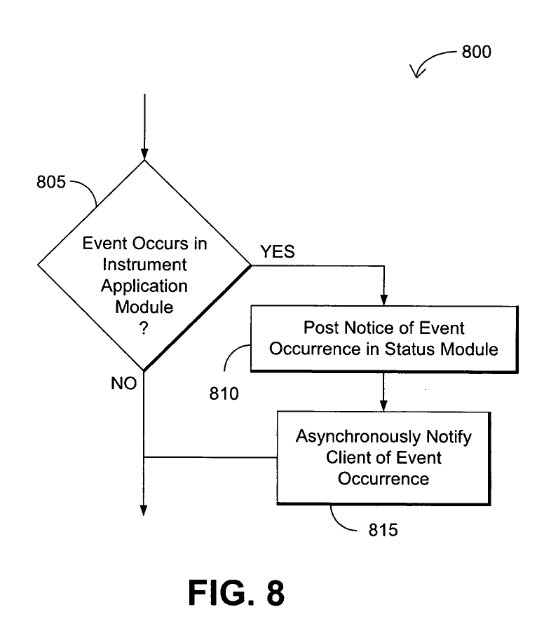

FIG. 8 is a drawing of a flow chart of a method 800 for transforming protocol of communications 108 on the communication path 121 of FIG. 4. FIG. 8 describes the typical method 800 used for communications 108 following the middle communication path 121 of FIG. 2 which transfers a notification of event occurrence 131 in the instrument application 110 to the client 105.

When an event occurs in the instrument application 110, block 805 transfers control to block 810. Otherwise, block 805 terminates the process.

In block 810, the application-notice of event occurrence 151 is posted in the status module 405. Block 810 then transfers control to block 815.

In block 815, the client 105 is asynchronously notified of event occurrence. Block 815 then terminates the process.

Following the notice of event occurrence to the client 105, the client 105 may or may not query the instrument 115 for additional information regarding the event, or the client 105 may simply query the instrument 115 to determine what events have occurred independent of the asynchronous notification indicated above. In which case, the instrument 115 will respond following the method 700 of FIG. 7, with information obtained from the status system 230.

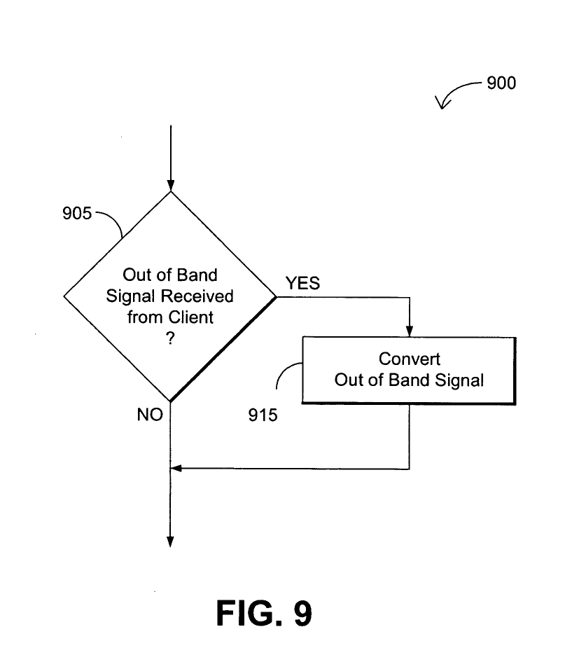

FIG. 9 is a drawing of a flow chart of a method 900 for transforming protocol of communications 108 on the communication path 121 of FIG. 5. FIG. 9 describes the typical method 900 used for communications 108 following the bottom communication path 121 of FIG. 2 which transfers out of band signals 124 from the client 105 to the instrument application 110.

When an out of band signal 124 is received from the client 105, block 905 transfers control to block 915. Otherwise, block 905 terminates the process.

In block 915, the out of band signal 124 is converted to a .NET event signal 524 and the .NET event is transferred to the instrument application 110. Block 915 then terminates the process.

As is the case, in many data-processing products, the techniques for translating between Standard Commands for Programmable Instrumentation (SCPI) protocol communications 108 and .NET protocol communications 108 described herein may be implemented as a combination of hardware and software components. Moreover, the functionality needed for using such implementations may be embodied in computer-readable media, such as 3.5 inch floppy disks, conventional hard disks, DVD's, CD-ROM's, Flash ROM's, nonvolatile ROM, RAM and the like, to be used in programming an information-processing apparatus (e.g., a computer and/or instrument 115) to perform in accordance with these implementations.

The term “program storage medium” is broadly defined herein to include any kind of computer memory such as, but not limited to, floppy disks, conventional hard disks, DVD's, CD-ROM's, Flash ROM's, nonvolatile ROM, RAM, and the like.

Client 105 and developer computers, as well as instruments 115 used with the measurement system 100, can be capable of running one or more of any commercially available operating system such as DOS, various versions of Microsoft Windows (Windows 95, 98, Me, 2000, NT, XP, or the like), Apple's MAC OS X, UNIX, Linux, or other suitable operating system.

While the present invention has been described in detail in relation to representative embodiments thereof, the described embodiments have been presented by way of example and not by way of limitation. In particular, embodiments have been presented describing the transformations back and forth between SCPI protocol communications and .NET protocol communications, but the concepts described herein are not limited to these protocols. It will be understood by those skilled in the art that various changes may be made in the form and details of the described embodiments resulting in equivalent embodiment that remain within the scope of the appended claims.

1. A method for translating between Standard Commands for Programmable Instrumentation (SCPI) protocol and .NET protocol communications, comprising:
when the communication is a SCPI protocol command from a client,
converting the SCPI protocol command to a .NET protocol command; and
evaluating the .NET protocol command to determine the validity of parameters sent from the client with the SCPI protocol command;
otherwise, when the communication is a SCPI protocol query from the client,
converting the SCPI protocol query to a .NET protocol query; and
evaluating the .NET protocol query to determine the validity of parameters sent from the client with the SCPI protocol query; and
calling an appropriate Application Program Interface (API) of an instrument application, wherein the communication is intended for the instrument application and wherein the API is responsive to method calls in the .NET protocol.

2. The method as recited in claim 1, further comprising:
before the method step converting the SCPI protocol command to the .NET protocol command, placing the SCPI protocol command into .NET stream format; and
before the method step converting the SCPI protocol query to the .NET protocol query, placing the SCPI protocol command into .NET stream format.

3. The method as recited in claim 1, further comprising:
when the query or the command is communication requiring response from the instrument application,
forming a .NET protocol response message to the communication;
translating the .NET protocol response message to a SCPI protocol response message, wherein the SCPI protocol response message comprises contents of nodes of a SCPI hieratical tree structure; and
transferring the SCPI protocol response message to the client.

4. The method as recited in claim 3, further comprising:
before the method step transferring the SCPI protocol response message to the client, converting the SCPI protocol response message to SCPI format order.

5. The method as recited in claim 1, further comprising:
asynchronously receiving an out of band IEEE 488.1 protocol signal from the client;
converting the out of band signal IEEE 488.1 protocol signal to a .NET event; and
transferring the out of band signal IEEE 488.1 protocol signal to the instrument application.

6. The method as recited in claim 1, further comprising:
when an event occurs in the instrument application,
posting a notice of event occurrence in a status module; and
asynchronously notifying the client of event occurrence.

7. The method as recited in claim 6, further comprising:
after the step asynchronously notifying the client of event occurrence,
receiving query from the client requesting detailed information regarding the event occurrence;
forming a .NET protocol response message to the query;
translating the .NET protocol response message to a SCPI protocol response message; and
transferring the SCPI protocol response message to the client.

8. A computer readable memory device embodying a computer program of instructions executable by the computer, the instructions comprising:
when the communication is a SCPI protocol command from a client,
converting the SCPI protocol command to a .NET protocol command; and
evaluating the .NET protocol command to determine the validity of parameters sent from the client with the SCPI protocol command;
otherwise, when the communication is a SCPI protocol query from the client,
converting the SCPI protocol query to a .NET protocol query; and
evaluating the .NET protocol query to determine the validity of parameters sent from the client with the SCPI protocol query; and
calling an appropriate Application Program Interface (API) of an instrument application, wherein the communication is intended for the instrument application and wherein the API is responsive to method calls in the .NET protocol.

9. The computer readable memory device as recited in claim 8, the instructions further comprising:
before the method step converting the SCPI protocol command to the .NET protocol command, placing the SCPI protocol command into .NET stream format; and
before the method step converting the SCPI protocol query to the .NET protocol query, placing the SCPI protocol command into .NET stream format.

10. The computer readable memory device as recited in claim 8, the instructions further comprising:
when the query or the command is communication requiring response from the instrument application,
forming a .NET protocol response message to the communication;
translating the .NET protocol response message to a SCPI protocol response message, wherein the SCPI protocol response message comprises contents of nodes of a SCPI hieratical tree structure; and
transferring the SCPI protocol response message to the client.

11. The computer readable memory device as recited in claim 10, the instructions further comprising:
before the method step transferring the SCPI protocol response message to the client, converting the SCPI protocol response message to SCPI format order.

12. The computer readable memory device as recited in claim 8, the instructions further comprising:
asynchronously receiving an out of band IEEE 488.1 protocol signal from the client;
converting the out of band signal IEEE 488.1 protocol signal to a .NET event; and
transferring the out of band signal IEEE 488.1 protocol signal to the instrument application.

13. The computer readable memory device as recited in claim 8, the instructions further comprising:
when an event occurs in the instrument application,
posting a notice of event occurrence in a status module; and
asynchronously notifying the client of event occurrence.

14. The computer readable memory device as recited in claim 13, the instructions further comprising:
after the step asynchronously notifying the client of event occurrence,
receiving query from the client requesting detailed information regarding the event occurrence;
forming a .NET protocol response message to the query;
translating the .NET protocol response message to a SCPI protocol response message; and
transferring the SCPI protocol response message to the client.

15. A system, comprising:
a parser module configured to receive a Standard Commands for Programmable Instrumentation (SCPI) protocol communication from a client and to translate the SCPI protocol communication into a .NET protocol communication; and
an evaluator module, configured to evaluate the .NET protocol communication to determine the validity of parameters sent from the client with the SCPI protocol communication.

16. The system as recited in claim 15, further comprising:
a first format converter module configured to convert the SCPI protocol communication into a .NET stream format.

17. The system as recited in claim 15, further comprising:
a first translator module configured to translate a .NET response from the instrument application to a SCPI protocol response.

18. The system as recited in claim 17, further comprising:
a second format converter module configured to convert the SCPI protocol response in a .NET stream format into SCPI format order.

19. The system as recited in claim 15, further comprising:
a third format converter module configured to convert an out of band IEEE 488.1 signal into a .NET signal.

20. The system as recited in claim 15, further comprising:
a status module comprising an event message queue and a status register wherein the message queue and the status register store event occurrence information from the instrument application;
an event translator module configured to receive notice of event occurrence from the status module and to translate that notice into a SCPI status notification.
